(19) United States
(12) Patent Application Publication
(10) Pub. No.: US 2015/0058786 A1
(43) Pub. Date: Feb. 26, 2015

(54) MOBILE TERMINAL AND STORAGE MEDIUM STORING MOBILE TERMINAL CONTROLLING PROGRAM

(71) Applicant: KYOCERA Corporation, Kyoto-shi (JP)

(72) Inventor: Ichiro KAJITANI, Osaka (JP)

(21) Appl. No.: 14/536,450

(22) Filed: Nov. 7, 2014

Related U.S. Application Data
(63) Continuation of application No. 13/001,590, filed on Dec. 27, 2010.

(30) Foreign Application Priority Data
Jun. 27, 2008 (JP) 2008-168259

(51) Int. Cl. G06F 3/0484; G06F 3/0488

(52) U.S. Cl. CPC G06F 3/04842; G06F 3/04847; G06F 3/04886
USPC 715/773

(57) ABSTRACT

A mobile terminal 10 is provided with a touch panel 36. The touch panel 36 is provided on a top surface of an LCD monitor 26 for displaying an operation area (R2) including a plurality of keys. When a user performs a sliding operation within the operation area (R2), a CPU 20 determines whether or not the sliding operation is a specific operation. Then, the CPU 20 sets an insensitive section on a touch sensitive area of the touch panel 36 when determining that the sliding operation is a specific operation.

### CROSS-REFERENCE TO RELATED APPLICATION

The present application is a continuation of U.S. application Ser. No. 13/001,590, filed on Dec. 27, 2010, which is a 371 of International Application No. PCT/JP2009/062164, filed on Jun. 26, 2009, which claims priority under 35 U.S.C. §119 to Japanese Patent Application No. 2008-168259, filed on Jun. 27, 2008. The content of each is incorporated herein by reference in its entirety.

### TECHNICAL FIELD

The present invention relates to a mobile terminal and a storage medium storing a mobile terminal controlling program. More specifically, the present invention relates to a mobile terminal and a storage medium storing a mobile terminal controlling program that are operated by a touch panel, for example.

### BACKGROUND ART

One example of this kind of an apparatus is disclosed in Japanese Patent Application Laid-Open No. 2000-39964 [G06F 3/033, H04N 5/225] (Patent Document 1) laid-open on Feb. 8, 2000. The background art is a monitor-equipped VTR with camera having a handwriting input apparatus. A monitor employs an LCD panel, and stacked on the LCD panel is a touch panel being made of transparent electrodes for detecting a handwritten input of an arbitrary design by a pen or a finger and a touch on an operation button display. Furthermore, the touch panel stacked on the LCD panel is called a touch screen.

When a power is supplied with the monitor-equipped VTR with camera, the touch screen is set as an invalid area at a width in the order of 2 mm from the end of the frame of the touch screen. Alternatively, in another example, only the area where the touch screen is likely to be touched can be set as an invalid area. In the invalid area, a handwritten input and a touch are made invalid, to thereby prevent an erroneous operation by the user from occurring.

However, in the Patent Document 1, a specific operation for changing the position where the invalid area is set is not disclosed. Furthermore, processing of making the invalid area effective is disclosed, but as to a cancel operation in a state that the monitor-equipped VTR with camera is supplied with power, a concrete operation is not disclosed.

### SUMMARY OF THE INVENTION

Therefore, it is a primary object of the present invention to provide a novel mobile terminal and a novel storage medium storing a mobile terminal controlling program.

Another object of the present invention is to provide a mobile terminal and a storage medium storing a mobile terminal controlling program that are able to easily set a insensitive section to a touch panel.

A still another object of the present invention is to provide a mobile terminal and a storage medium storing a mobile terminal controlling program that are able to easily cancel the insensitive section set to the touch panel.

The present invention employs following features in order to solve the above-described problems. It should be noted that reference numerals inside the parentheses and the supplementary explanations show one example of a corresponding relationship with the embodiments described later for easy understanding of the present invention, and do not limit the present invention.

A first invention is mobile terminal, comprising: a display portion which displays an operation key; a touched position detecting portion which is provided on the display portion, and detects a touched position within a touch sensitive area corresponding to a display area of the display portion; a specific operation determining portion which determines whether or not a specific operation is performed on the basis of information from a starting position to a current position of the touch input detected by the touched position detecting portion; and an insensitive section setting portion which sets an insensitive section making an operation with respect to the operation key invalid to the touch sensitive area when the specific operation determining portion determines that the specific operation is performed.

In the first invention, a display portion (26) of a mobile terminal (10) displays an operation key. A touched position detecting portion (20, 34, 36, S3, S181) is provided to the display portion, and detects a touched position within a touch sensitive area corresponding to a display area (R1, R2, R3) of the display portion. A specific operation determining portion (20, S11, S183, S185) determines whether or not a specific operation is performed on the basis of information from a starting position (starting point of the touch) to a current position of the touch input detected by the touched position detecting portion. An insensitive section setting portion (20, S15, S87, S187) sets an insensitive section making an operation with respect to the operation key invalid to the touch sensitive area when the specific operation determining portion determines that the specific operation is performed.

For example, the touched position detecting portion detects a touched position by a touch panel provided on the display portion. Then, if the specific operation determining portion determines that the specific operation is performed on the basis of the information from a starting position to a current position, the insensitive section is set to the touch sensitive area of the touch panel.

According to the first invention, by merely performing the specific operation on the touch panel, a user can easily set the insensitive section.

A second invention is according to the first invention, wherein the specific operation determining portion further includes a first sliding operation determining portion which determines whether or not a sliding operation is performed on the basis of the information from the starting position to the current position; and a deciding portion which decides a specific operation is performed when the first sliding operation determining portion determines that a sliding operation is performed.

In the second invention, a first sliding operation determining portion (20, S51, S111, S183) determines whether or not a sliding operation is performed on the basis of the information from the starting position to the current position. A deciding portion (20, S63, 5127) decides a specific operation is performed when the first sliding operation determining portion determines that a sliding operation is performed. That is, when a sliding operation is performed on the touch panel, it is decided that a specific operation is performed.

According to the second invention, by merely performing the sliding operation on the touch panel, the user can set the insensitive section.

A third invention is according to the second invention, wherein the specific operation determining portion further includes a first sliding direction detecting portion which detects a sliding direction on the basis of the information from the starting position to the current position, and the deciding portion decides that the specific operation is performed when the first sliding operation determining portion determines that a sliding operation is performed, and the first sliding direction detecting portion detects that the detected sliding direction is a first specific direction.

In the third invention, a first sliding direction detecting portion (20, S55, S119) detects a sliding direction on the basis of the information from the starting position to the current position. The deciding portion decides that the specific operation is performed when the first sliding operation determining portion determines that a sliding operation is performed, and the sliding direction detected by the first sliding direction detecting portion is a first specific direction (in a lateral direction or a longitudinal direction). For example, the first specific direction is the lateral direction or the longitudinal direction, and a direction decided in advance. Accordingly, the deciding portion decides that the specific operation is performed on condition that the sliding direction of the sliding operation is the first specific direction.

According to the third invention, the user performs an operation such that the sliding direction of the sliding operation is coincident with the direction decided in advance to thereby set the insensitive section.

A fourth invention is according to the third invention, wherein the specific operation determining portion further includes a first attitude detecting portion which detects a terminal attitude of the mobile terminal, the deciding portion decides that the specific operation is performed when the first sliding operation determining portion determines that a sliding operation is performed, and the sliding direction detected by the first sliding direction detecting portion has a first specific relationship with the terminal attitude detected by the first attitude detecting portion.

The fourth invention is according to the third invention, and the specific operation determining portion further includes a first attitude detecting portion (20, 38, S53, S119) which detects a terminal attitude of the mobile terminal, the deciding portion decides that the specific operation is performed when the first sliding operation determining portion determines that a sliding operation is performed, and the sliding direction detected by the first sliding direction detecting portion has a first specific relationship with the terminal attitude detected by the first attitude detecting portion. For example, the first specific relationship is established on condition that the sliding direction is in the longitudinal direction when the terminal attitude is the horizontally-disposed manner, or the sliding direction is the lateral direction when the terminal attitude is the vertically-disposed manner. Furthermore, the first specific relationship is decided in advance.

According to the fourth embodiment, in accordance with the terminal attitude as to how the mobile terminal is held, the sliding operation that allows an easy operation for the user can be decided as a specific operation, and therefore, the user can perform an easily operable sliding operation irrespective of the terminal attitude as to how the mobile terminal is held.

A fifth invention is according to the third or the fourth invention, wherein the display area further includes a specific position, the first sliding operation determining portion further includes a starting position determining portion which determines whether or not the starting position is coincident with the specific position, and the deciding portion decides that the sliding operation is the specific operation on condition that the starting position determining portion determines that the starting position is coincident with the specific position.

In the fifth invention, in the display area, a specific position (A) is further included. The starting position determining portion (20, S113) determines whether or not the starting position is coincident with the specific position. Then, the deciding portion decides that the sliding operation is the specific operation on condition that the starting position determining portion determines that the starting position is coincident with the specific position. For example, the specific position is a vertex of the display area.

A sixth invention is according to any one of the second to fifth inventions, wherein the display area further includes a specific section, the first sliding operation determining portion further includes a specific section determining portion which determines whether or not the sliding operation is performed within the specific section, and the deciding portion decides that the sliding operation is the specific operation on condition that the specific section determining portion determines that the sliding operation is performed within the specific section.

In the sixth invention, the display area further includes a specific section (R2). A specific section determining portion (20, S51) determines whether or not the sliding operation is performed within the specific section. Then, the deciding portion decides that the sliding operation is the specific operation on condition that the specific section determining portion determines that the sliding operation is performed within the specific section.

According to the fifth invention and the sixth invention, the user easily operates the touch panel by making a discrimination between the specific operation and the normal operation.

A seventh invention is according to any one of the first to sixth inventions, further comprising a insensitive section cancelling portion which cancels the insensitive section when the touched position detecting portion detects an end position of the touch input.

In the seventh invention, an insensitive section cancelling portion (20, S37, S83, S197) cancels the insensitive section when the touched position detecting portion detects an end position of the touch input.

According to the seventh invention, by releasing the finger from the touch panel, the user can easily cancel the insensitive section.

An eighth invention is according to the seventh invention, further comprising: a time counting portion (S33, S193) which counts a time when the touched position detecting portion detects the end position of the touch input, and a time determining portion (S35,S195) which determines whether or not the time counted by the time counting portion is equal to or more than a predetermined time, wherein the insensitive section cancelling portion cancels the insensitive section on condition that the time determining portion determines to be equal to or more than the predetermined time.

In the eighth invention, the time counting portion (20, S33, S193) counts a time when the touched position detecting portion detects the end position of the touch input. The time determining portion (20, S35, S195) determines whether or not the time counted by the time counting portion is equal to or more than a predetermined time. Then, the insensitive section cancelling portion cancels the insensitive section on condition that the time determining portion determines to be equal to or more than the predetermined time.

According to the eighth invention, the insensitive section is not cancelled if only it is within a predetermined time even if the finger is released from the touch panel, capable of improving user's convenience.

A ninth invention is according to the seventh invention, further comprising an end position determining portion which determines whether or not the end position is coincident with the specific position when the end position by the touch input is detected by the touched position detecting portion, wherein the insensitive section cancelling portion cancels the insensitive section when the end position determining portion determines that the starting position and the specific position are coincident with each other.

In the ninth invention, an end position determining portion (20, S81) determines whether or not the end position is coincident with the specific position when the end position by the touch input is detected by the touched position detecting portion. Then, the insensitive section cancelling portion cancels the insensitive section when the end position determining portion determines that the starting position and the specific position are coincident with each other.

According to the ninth invention, the user performs an operation such that the specific position becomes the end point on the touch panel to thereby cancel the insensitive section.

A tenth invention is according to the ninth invention, further comprising a second sliding operation determining portion which determines whether or not a sliding operation is performed on the basis of the information from the starting position to the current position of the touch input detected by the touched position detecting portion, and the end position determining portion determines whether or not the end position is coincident with the specific position when the sliding operation determining portion determines that a sliding operation is performed.

In the tenth invention, a second sliding operation determining portion (20, S111) determines whether or not a sliding operation is performed on the basis of the information from the starting position to the current position of the touch input detected by the touched position detecting portion. Then, the end position determining portion determines whether or not the end position is coincident with the specific position when the sliding operation determining portion determines that a sliding operation is performed.

According to the tenth invention, the user merely performs a sliding operation such that the end point is coincident with the insensitive section to thereby cancel the insensitive section.

An eleventh invention is according to the tenth invention, further comprising: a second sliding direction detecting portion which detects a sliding direction on the basis of the information from the starting position to the current position, wherein the end position determining portion determines whether or not the end position is coincident with the specific position when a sliding operation is performed by the sliding operation determining portion, and the sliding direction detected by the second sliding direction detecting portion is the second specific direction.

In the eleventh invention, a second sliding direction detecting portion (20, S119) detects a sliding direction on the basis of the information from the starting position to the current position. Then, the end position determining portion determines whether or not the end position is coincident with the specific position when a sliding operation is performed by the sliding operation determining portion, and the sliding direction detected by the second sliding direction detecting portion is the second specific direction. For example, the second specific direction is a direction decided in advance similar to the first specific direction.

According to the eleventh invention, the user merely performs a sliding operation such that the end point becomes the specific position in the sliding direction decided in advance to thereby cancel the insensitive section.

A twelfth invention is according to the eleventh invention, further comprising a second attitude detecting portion which detects a terminal attitude of the mobile terminal, the end position determining portion determines whether or not the end position is coincident with the specific position when the sliding operation determining portion determines that the sliding operation is performed, and the sliding direction detected by the second sliding direction detecting portion has a second specific relationship with the terminal attitude detected by the second attitude detecting portion.

In the twelfth invention, a second attitude detecting portion (20, 38, S117) detects a terminal attitude of the mobile terminal. Then, the end position determining portion determines whether or not the end position is coincident with the specific position when the sliding operation determining portion determines that the sliding operation is performed, and the sliding direction detected by the second sliding direction detecting portion has a second specific relationship with the terminal attitude detected by the second attitude detecting portion. For example, the second specific relationship is a relationship decided in advance, and is established on condition that the sliding direction is the lateral direction when the terminal attitude is the horizontally-disposed manner, or the sliding direction is the longitudinal direction when the terminal attitude is the vertically-disposed manner.

According to the twelfth invention, when the user holds the mobile terminal such that the terminal attitude of the mobile terminal and the sliding direction take a relationship decided in advance and performs a sliding operation such that the end point becomes the specific position, the insensitive section can be canceled. Thus, it is possible to operate the touch panel by making a discrimination between an operation of cancelling the insensitive section and an operation of holding the mobile terminal.

A thirteenth invention is according to any one of the first to twelfth inventions, further comprising: a feed back portion which performs a feedback operation when the touched position detecting portion detects the touch input; and a prohibiting portion which prohibits the feedback operation by the feed back portion when the insensitive section setting portion sets the insensitive section.

In the thirteenth invention, a feed back portion (40) performs a feedback operation when the touched position detecting portion detects the touch input. A prohibiting portion (20, S17, S89, S189) prohibits the feedback operation by the feed back portion when the insensitive section setting portion sets the insensitive section. For example, the feed back portion performs a feedback by rotative vibrations of a motor, etc.

A fourteenth invention is according to the thirteenth invention, further comprising: a feedback prohibition cancelling portion which cancels the prohibition of the feedback operation prohibited by the prohibiting portion when the insensitivity cancelling portion cancels the insensitive section.

In the fourteenth invention, a restarting portion (20, S39, S85, S199) restarts the feedback operation by the feed back portion when the insensitive section is canceled by the insensitivity cancelling portion.

According to the thirteenth and fourteenth inventions, in accordance with the setting or cancelation of the insensitive section, the feedback operation is prohibited or canceled, and therefore, the user can clearly perceive the setting or cancellation of the insensitive section.

A fifteenth invention is according to any one of the first to fourteenth inventions, wherein the insensitive section is the same size as the touch sensitive area.

A sixteenth invention is according to any one of the first to fourteenth inventions, wherein the insensitive section is smaller than the touch sensitive area.

According to the fifteenth invention or the sixteenth invention, the insensitive section can be set to the entire or a part of the touch sensitive area. Thus, the user can arbitrarily set the size of the insensitive section.

A seventeenth invention is storage medium storing a mobile terminal controlling program of a mobile terminal (10) including a display portion (16) for displaying an operation key (50, 52, 54) so as to be read by a processor (20) of the mobile terminal, the mobile terminal controlling program causes the processor to execute: a touched position detecting step (S3, S181) for detecting a touched position within a touch sensitive area corresponding to a display area (R1, R2, R3) of the display portion; a specific operation determining step (S11, S183, S185) for determining whether or not a specific operation is performed on the basis of information from a starting position to a current position of the touch input detected by the touched position detecting step; and an insensitive section setting step (S15, S87, S187) for setting an insensitive section making an operation with respect to the operation key invalid to the touch sensitive area when the specific operation determining step determines that the specific operation is performed.

In the seventeenth invention as well, by merely performing the specific operation on the touch panel, a user can easily set the insensitive section.

An eighteenth invention is according to the seventeenth invention, and is a storage medium storing a mobile terminal controlling program to execute an insensitive section cancelling step (20, S37, S83, S197) which cancels the insensitive section when the touched position detecting step detects the end position of the touch input.

In the eighteenth invention as well, similar to the seventh invention, the user can easily cancel the insensitive section by merely releasing the finger from the touch panel.

According to the present invention, by merely performing the specific operation on the touch panel, the user can easily set the insensitive section.

Furthermore, by merely releasing the finger from the touch panel, the user can easily cancel the insensitive section.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an electric configuration of a mobile terminal of one embodiment of the present invention.

FIG. 2 is an illustrative view showing an appearance of the mobile terminal shown in FIG. 1.

FIG. 3 is an illustrative view showing one example of a situation in which the mobile terminal shown in FIG. 1 executes a TV displaying function.

FIG. 4 is an illustrative view showing one example of a situation in which the mobile terminal shown in FIG. 1 is held.

FIG. 5 is an illustrative view showing one example of a situation in which a touch panel of the mobile terminal shown in FIG. 1 is operated.

FIG. 6 is an illustrative view showing one example of a memory map of a RAM shown in FIG. 1.

FIG. 7 is an illustrative view showing a part of a data memory area stored in the RAM shown in FIG. 6.

FIG. 8 is a flowchart showing a part of touch panel controlling processing by a CPU shown in FIG. 1.

FIG. 9 is a flowchart showing another part of the touch panel controlling processing by the CPU shown in FIG. 1, and sequel to FIG. 8.

FIG. 10 is a flowchart showing operation result determining processing by the CPU shown in FIG. 1.

FIG. 11 is an illustrative view showing one example of a situation in which a touch panel of a mobile terminal of a second embodiment is operated.

FIG. 12 is a flowchart showing touch panel controlling processing by the CPU of the second embodiment.

FIG. 13 is a flowchart showing operation result determining processing of the second embodiment by the CPU.

FIG. 14 is an illustrative view explaining touch detection by a touch switch of a third embodiment.

FIG. 15 is flowchart showing touch switch controlling processing by the CPU of the third embodiment.

### BEST MODE FOR PRACTICING THE INVENTION

### First Embodiment

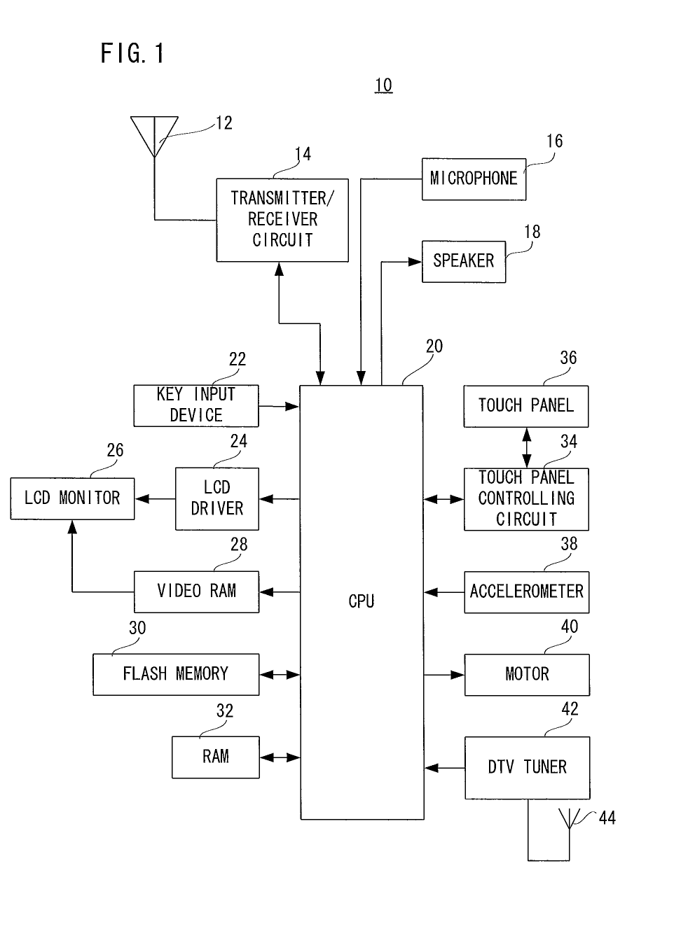

Referring to FIG. 1, a mobile terminal 10 includes a CPU (referred to as a processor or a computer.) 20, a key input device 22 and a touch panel 36 to be controlled by a touch panel controlling circuit 34. The CPU 20 controls a transmitter/receiver circuit 14 corresponding to a CDMA system to output a calling signal. The output calling signal is issued from an antenna 12, and sent to a mobile communication network including base stations. When a communication partner performs an off-hook operation, a communication allowable state is established.

After a transition to the communication allowable state is made, when a speech communication end operation is performed by the key input device 22 or the touch panel 36, the CPU 20 controls the transmitter/receiver circuit 14 to transmit a speech communication end signal to the communication partner. After transmitting the speech communication end signal, the CPU 20 ends the speech communication processing. If a speech communication end signal is received from the communication partner first as well, the CPU 20 ends the speech communication processing. Furthermore, if the speech communication end signal is received not from the communication partner but from the mobile communication network as well, the CPU 20 ends the speech communication processing.

When a calling signal from the communication partner is received by the antenna 12 in a state that the mobile terminal 10 is activated, the transmitter/receiver circuit 14 notifies the CPU 20 of an incoming call. The CPU 20 controls an LCD monitor 26 by an LCD driver 24, and stores an image necessary for depicting in a video RAM 28 to thereby display calling source information described in the incoming call notification on the LCD monitor 26. Furthermore, the CPU 20 outputs an incoming call tone from an incoming call notifying speaker not illustrated.

Following processing is executed in the communication allowable state. A modulated audio signal transmitted from the communication partner (high frequency signal) is received by the antenna 12. The received modulated audio signal undergoes demodulation processing and decoding processing by the transmitter/receiver circuit 14. The received voice signal thus acquired is output from the speaker 18. A voice signal to be transmitted caught by the microphone 16 undergoes encoding processing and modulation processing by the transmitter/receiver circuit 14. The modulated audio signal thus generated is transmitted to the communication partner by using the antenna 12 as described above.

The touch panel 36 is a pointing device for designating an arbitrary position within the screen of the LCD monitor 26 by the user. The touch panel 36 is operated by being pressed, slid (stroked), touched on its top surface with a finger to thereby detect the operation. Then, when the touch panel 36 detects a touch, the touch panel controlling circuit 34 specifies the operated position, and outputs the coordinates data of the operated position to the CPU 20. That is, by pressing, sliding, and touching the top surface of the touch panel 36 with the finger, the user can input a direction of an operation and a design to the mobile terminal 10.

Furthermore, the touch panel 36 detects that it is touched by the finger according to a type called an electrical capacitance type for detecting a change in capacitance between electrodes occurring when the finger approaches the top surface of the touch panel 36. Here, as the touch panel 36, a projection electrical capacitance type that forms a pattern of electrodes on a transparent film, etc., and detects a change in capacitance between electrodes occurring due to an approach of the finger is adopted. In addition, a surface electrical capacitance type may be adopted, and a resistance film system, an ultrasonic type, an infrared ray type and an inductive coupling type, etc. may be adopted as a detection system.

Here, an operation of touching the top surface of the touch panel 36 with the finger by the user is called “touch”. On the other hand, an operation of releasing the finger from the touch panel 36 is called “release”. The coordinates designated by a touch is called a “starting point of the touch”, and the coordinates of an end position of the operation designated by a release is called an “end point of the touch”. In addition, an operation of touching the top surface of the touch panel 36 by the user, and then releasing it is called a “touch operation”. Here, an operation with respect to the touch panel 36 may be performed by a bar taking a tapered shape, such as a pen without being restricted to the finger. Furthermore, a dedicated touch pen may be provided in order to perform an operation.

The touched position in a case that a touch is performed with the finger is the center of gravity of the area of the finger that touches the touch panel 36. Here, when the touched position may be the center of gravity of the area of the finger that touches the touch panel 36, the area of the finger that touches the touch panel 36 may change regardless of user's intention. Thus, when the user perceives that he or she does not move the touched position, the CPU 20 detects that the touched position is moved. Thereupon, if the moving amount of the touched position is little (equal to or less than 10 dots on the LCD monitor 26), the CPU 20 determines that the touched position is not changed.

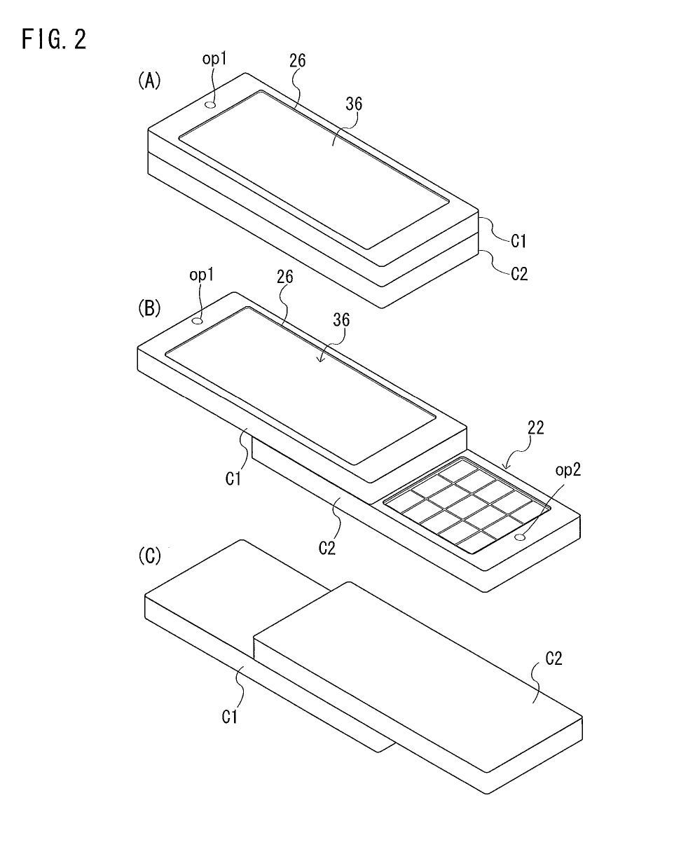

Each of FIG. 2(A) to FIG. 2(C) is an illustrative view showing an appearance of the mobile terminal 10. With reference to FIG. 2 (A) to FIG. 2(C), the mobile terminal 10 has a case C1 and a case C2 each of which is formed in a tabular shape. The thickness of each of the cases C1 and C2 is approximately the same. In FIG. 2, the microphone 16 not shown is contained in the case C2, and the speaker 18 is contained in the case C1. An opening op2 communicated with the contained microphone 16 is provided on the top surface at one end of the longitudinal direction of the case C2, and the opening op1 communicated with the contained speaker 18 is provided on the top surface at one end of the longitudinal direction of the case C1. That is, the user listens to a sound output from the speaker 18 through the opening op1, and inputs a sound to the microphone 16 through the opening op2.

The key input device 22 is provided on a top surface of the case C2. By operating the key input device 22 or the touch panel 36, the user performs talk start/end operations and turning on/off operations of the power source of the mobile terminal 10. The LCD monitor 26 is attached so as to be exposed from the top surface of the monitor screen, and on the top surface of the LCD monitor 26, a touch panel 36 is provided.

The case C1 and case C2 contain an open/close mechanism not shown. Then, the case C1 can be moved in a lengthwise direction of the case C2 in a state that it is stacked on the case C2. In addition, the open/close mechanism includes an assist mechanism of assisting the case C1 by a spring mechanism.

Furthermore, a state shown in FIG. 2 (A) is called a “closed position”, and a state shown in FIG. 2(B) and FIG. 2(C) is called an “open position”. Then, the CPU 20 detects an open position and a closed position by a magnetic sensor and a magnet not shown.

Here, as to the case C1, the LCD monitor 26, the touch panel 36, the opening op1 and the case C1, the detailed explanations thereof are omitted for simplicity in other illustrative views.

The mobile terminal 10 is provided with a TV displaying function, and displays a video image by a digital broadcast on the LCD monitor 26 in response to an operation of executing the TV displaying function by the key input device 22 or the touch panel 36. More specifically, a DTV tuner 42 extracts a digital broadcast signal corresponding to the selected channel from the digital broadcast signal received by the antenna 44. Furthermore, the DTV tuner 42 performs digital demodulation, etc. on the extracted digital broadcast signal to thereby generate a demodulated signal. In addition, the DTV tuner 42 outputs the demodulated signal to the mobile terminal 10. The mobile terminal 10 performs decoding processing on the demodulated signal according to an MPEG system to generate a video signal. Then, the generated video signal is output to the LCD monitor 26, and whereby, a video image of the selected channel by the digital broadcast is displayed on the LCD monitor 26.

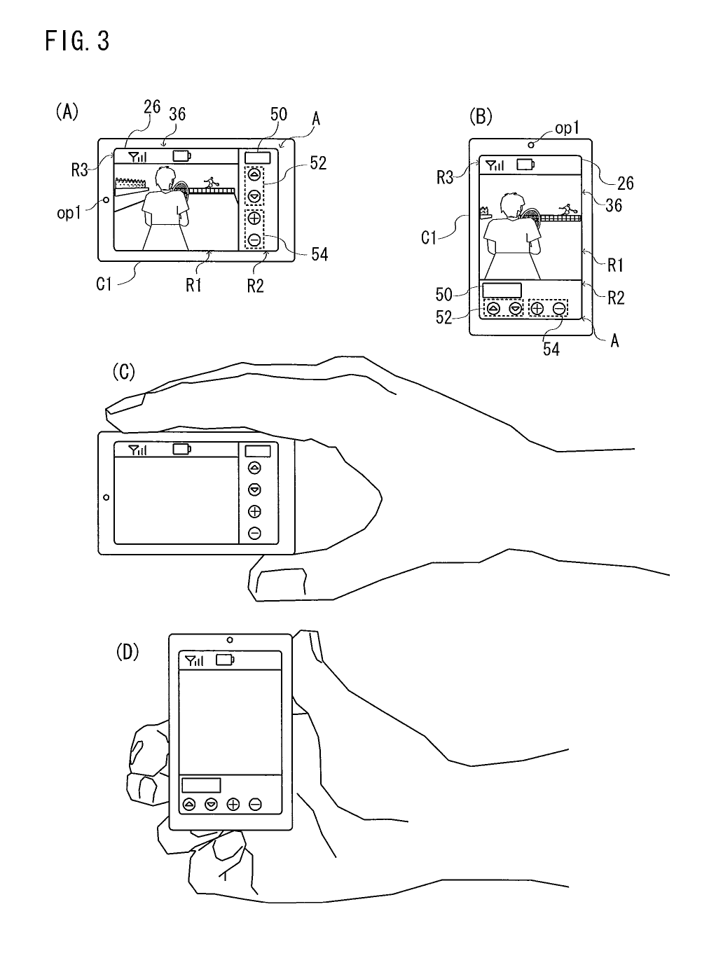

Each of FIG. 3(A) and FIG. 3(B) is an illustrative view showing an appearance of the mobile terminal 10 executing the TV displaying function. With reference to FIG. 3(A) and FIG. 3(B), a TV area R1, an operation area R2 and a state displaying area R3 are displayed on the LCD monitor 26. The TV area R1 is an area where a video image which is being received by the digital broadcast is displayed. The operation area R2 is an area including keys on which the user performs operation in the TV displaying function, and includes a menu key 50, a channel key 52 and a volume key 54. The menu key 50 is a key displaying a GUI for ending the TV displaying function and for changing the settings. The channel key 52 is a key for selecting a channel of the digital broadcast that is being received (changing the channel number). The user can increment the channel number with the upward channel key 52 and decrement the channel number with the downward channel key 52. The volume key 54 is a key for adjusting a volume corresponding to the digital broadcast displayed in the TV area. The user makes the volume high by the volume key 54 represented by “+”, and makes the volume low by the volume key 54 represented by “−”.

Furthermore, the TV displaying function includes a feedback function for, when an operation is performed on the touch panel 36, feeding back the operation to the user by motor vibrations of the motor 40. For example, when the user selects a channel with the channel key 52, the CPU 20 rotates the motor 40 in accordance with the execution of the channel selecting processing, and vibrates the mobile terminal 10 by a rotation of the motor 40. Then, every time the user selects a channel by the channel key 52, the mobile terminal 10 is vibrated, that is, fed back, and therefore, the user can know that his or her own channel selecting operation succeeds.

Here, without being restricted to the TV displaying function, in another function as well, every time that an operation is performed via the touch panel 36, a feedback function is made to be executed. In addition, the vibration by the motor 40 may be utilized as a vibration function of notifying the user of an incoming call. Moreover, the feedback function is implemented by outputting a sound from the speaker not shown as well as the vibrations by the motor 40.

The state displaying area R3 is an area in which a state of the mobile terminal 10 is displayed, and includes icons indicating an electromagnetic wave receiving state and a state of the remaining amount of the battery of the mobile terminal 10.

Furthermore, the upper-right hand corner of the LCD monitor 26 in a vertically-disposed manner shall be a specific position A. The specific position A is described later in another embodiment, and therefore, the detailed explanation is omitted here. In addition, the CPU 20 detects a change of the attitude of the mobile terminal 10 from the data of an acceleration (acceleration data) output from the accelerometer 38 to switch the display direction of the LCD monitor 26. For example, when the mobile attitude of the mobile terminal 10 is changed from the horizontally-situated manner shown in FIG. 3(A) to the vertically-situated manner shown in FIG. 3(B), the display direction of the LCD monitor 26 changes from a lateral direction to a longitudinal direction in accordance with the change of the attitude of the mobile terminal. Here, the specific position A is always at the same position on the LCD monitor 26, and therefore, in the vertically-situated direction, the lower-right hand corner of the LCD monitor 26 shall be the specific position A.

Here, the TV area R1, the operation area R2 and the state displaying area R3 are the same as those in other illustrative views, and therefore, in other illustrative views, a detailed description is explained for simplicity. In addition, with respect to the TV area R1, the displayed content is also omitted.

Each of FIG. 3(C) and FIG. 3(D) is an illustrative view showing a situation in which the mobile terminal 10 is held by the user in a case that the TV displaying function is executed. FIG. 3(C) is an illustrative view when the mobile terminal 10 is held in a horizontally-disposed manner, and FIG. 3(D) an illustrative view when the mobile terminal 10 is held in a vertically-disposed manner. In either case of FIG. 3(C) or FIG. 3 (D), the user holds the mobile terminal 10 with the side surfaces of the mobile terminal 10 pinched with the finger so as not to perform an erroneous operation on the touch panel 36 with the finger.

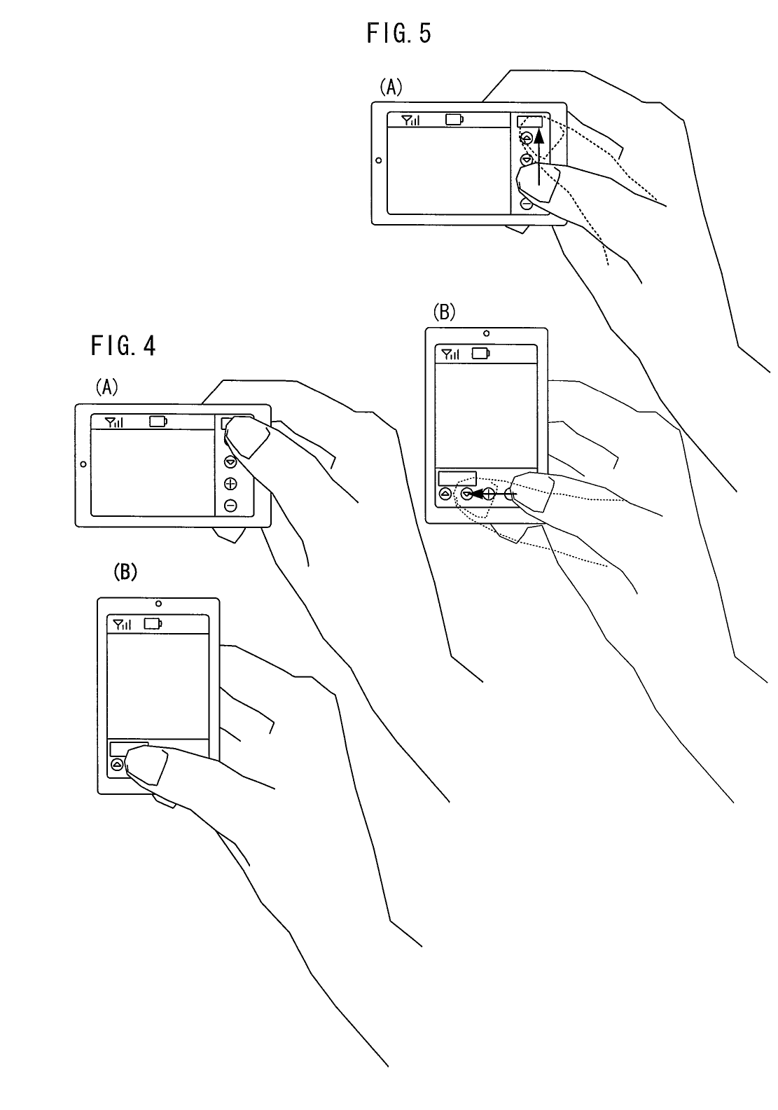

However, in a case that the user enjoys viewing the digital broadcast by the TV displaying function for a long time, when he or she holds the mobile terminal 10 with the side surfaces pinched as shown in FIG. 3(C) or FIG. 3(D), the user cannot view the TV for a long time due to fatigue of the hand. As a holding manner causing less fatigue even after a holding for a long time, it is conceivable that holding the mobile terminal 10 for a long time is implemented by pinching the mobile terminal 10 with the thumb on the top surface of the case C1 and the other fingers on the bottom surface of the case C2 as shown in FIG. 4(A) and FIG. 4(B), but an unintended touch on the operation area R2 with the finger causes an unnecessary channel selection or a volume adjustment. Furthermore, the touch panel 36 has a size approximately the same as the top surface of the case C1, and therefore, it is difficult to hold the mobile terminal 10 so as to pinch it between the fingers on the top surface of the case C1 and the bottom surface of the case C2 without a touch of the touch panel 36.

Hereupon, a specific operation is performed on the specific section to set an insensitive section making an operation corresponding to each key invalid within the touch sensitive area of the touch panel 36, and whereby, an erroneous operation on the touch panel 36 is prevented. Here, the touch sensitive area has coordinates the same as those of the display area of the LCD monitor 26.

More specifically, the specific section is regarded as an operation area R2, and a specific sliding operation is performed on the operation area R2 to thereby set the specific section. For example, with reference to FIG. 5(A), if the attitude of the mobile terminal is the horizontally-disposed manner, when the user performs a sliding operation from bottom to top on the operation area R2 with the thumb, the entire touch sensitive area can be set as an insensitive section. In addition, with reference to FIG. 5(B), as to the vertically-disposed manner, when the user performs a sliding operation from right to left on the operation area R2 with the thumb, the entire touch sensitive area can be set as an insensitive section. Then, during a time from a sliding operation to the release of the thumb from the touch panel 36, the insensitive section remains to be set, and therefore, it is possible to prevent an erroneous operation on the menu key 50, the channel key 52 and the volume key 54 within the operation area R2 from occurring. In addition, the user can easily set the insensitive section by merely performing a specific sliding operation.

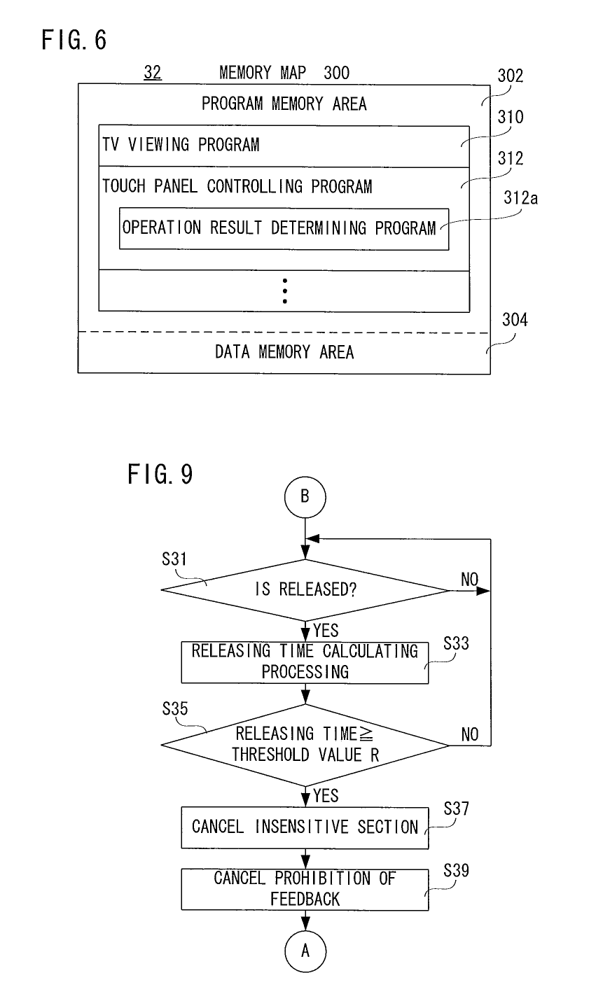

FIG. 6 is an illustrative view showing a memory map of the RAM 32. Referring to FIG. 6, in the memory map 300 of the RAM 32, a program memory area 302 and a data memory area 304 are included. A part of the program and data are read entirely at a time, or partially and sequentially as required from the flash memory 30 to be stored in the RAM 32, and executed by the CPU 20, etc.

The program memory area 302 stores a program for operating the mobile terminal 10. The program for operating the mobile terminal 10 is made up of a TV displaying program 310, a touch panel controlling program 312, etc. Here, the touch panel controlling program 312 includes an operation result determining program 312a.

The TV displaying program 310 is a program for displaying a digital broadcast by the mobile terminal 10. The touch panel controlling program 312 is a program for processing a touch, etc. with respect to the touch panel 36. Furthermore, the operation result determining program 312a is a program for determining whether or not an operation after the touch is the specific operation.

Although illustration is omitted, the program for operating the mobile terminal 10 includes a talk control program, etc.

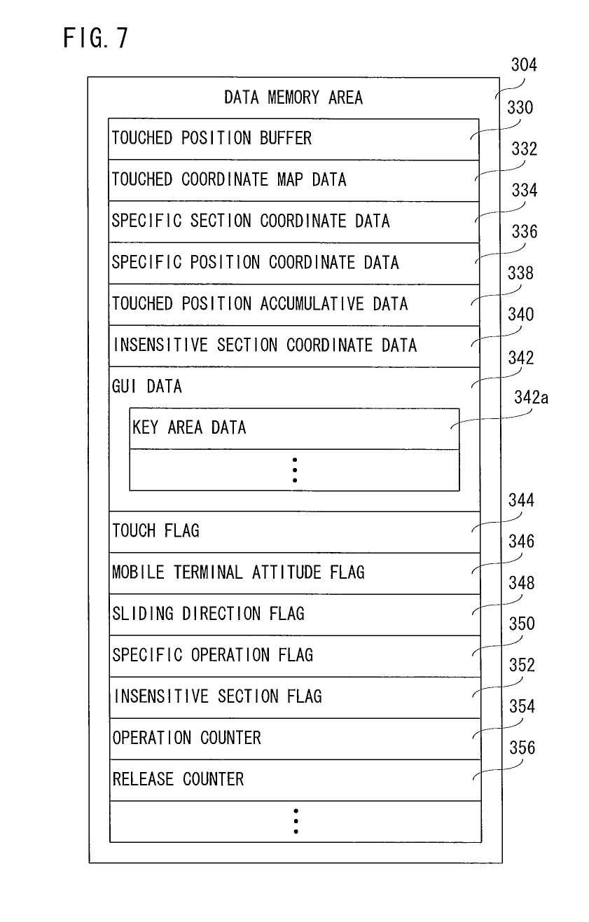

As shown in FIG. 7, the data memory area 304 is provided with a touched position buffer 330. Furthermore, in the data memory area 304, touched coordinate map data 332, specific section coordinate data 334, specific position coordinate data 336, touched position accumulative data 338, insensitive section coordinate data 340 and GUI data 342 are stored, and a touch flag 344, a mobile terminal attitude flag 346, a specific operation flag 350, an operation counter 352, a release counter 354, etc. are provided. Here, the GUI data 342 includes a key area data 342a.

The touched position buffer 330 is a buffer for temporarily storing an input result by a touch, etc. detected by the touch panel 36, and stores coordinate data of a starting point of the touch, an end point of the touch, and a current touched position. The touched coordinate map data 332 is data for bringing a position of a touch, etc. specified by the touch panel controlling circuit 38 into correspondence with the display position of the LCD monitor 26. Thus, the CPU 20 can bring the position of the touch operation specified by the touch panel controlling circuit 38 based on the touched coordinate map data 332 into correspondence with the display of the LCD monitor 26.

The specific section coordinate data 334 is coordinate data of the specific section, and has coordinate data the same as that of the display area of the operation area R2 in the first embodiment. Here, the specific section coordinate data 334 may be the same as the coordinate data indicating the display area of the LCD monitor 26. The specific position coordinate data 336 is coordinate data of the specific position A shown in FIG. 3(A), FIG. 3(B), and is coordinate data indicating the upper-right hand corner of the LCD monitor 26 in the horizontally-disposed manner in FIG. 3(A).

The touched position accumulative data 338 is data of accumulating the coordinate data of the detected touched positions from a touch of the touch panel to a release thereof. The insensitive section coordinate data 340 is area coordinate data of an insensitive section set within the touch sensitive area, and is coincident with the coordinate data of the touch sensitive area in the touch panel 36 in this embodiment. Here, the insensitive section coordinate data 340 is designed to be coincident with touched position recording data always recording touched position and being made up of the accumulated touched position and touched position history data being made up of history data of the touched position in place of the touched position accumulative data 338.

The GUI data 342 is coordinate data of GUIs to be displayed on the LCD monitor 26, and the key area data 342a is made up of coordinate data of the display area of the operation key, such as the menu key 50, the channel key 52, the volume key 54, etc.

The touch flag 344 is a flag for determining whether or not the touch panel 36 is touched (contacted). For example, the touch flag 344 is constituted of one bit register. When the touch flag 344 is established (turned on), a data value “1” is set to the register, and when the touch flag 344 is not established (turned off), a data value of “0” is set to the register.

The mobile terminal attitude flag 346 is a flag for determining whether or not the attitude of the mobile terminal 10 is in the horizontally-disposed manner or the vertically-disposed manner For example, the mobile terminal attitude flag 346 is constituted of one bit register. The mobile terminal attitude flag 346 is established (turned on), and a data value “1” is set to the register if the mobile terminal 10 is in the horizontally-disposed manner as shown in FIG. 3(A). On the other hand, the mobile terminal attitude flag 346 is not established (turned off), and a data value “0” is set to the register if the mobile terminal 10 is in the vertically-disposed manner as shown in FIG. 3(B).

The sliding direction flag 348 is a flag for determining whether a sliding operation is performed in the longitudinal direction or in the lateral direction. For example, the sliding direction flag 348 is constituted of one bit register. The sliding direction flag 348 is established (turned on), and a data value “1” is set to the register if the sliding direction is the lateral direction. On the other hand, the sliding direction flag 348 is not established (turned off) if the sliding direction is the longitudinal direction.

The specific operation flag 350 is a flag for determining whether or not a specific operation is performed. For example, the specific operation flag 350 is constituted of one bit register. When the specific operation flag 350 is established (turned on), a data value “1” is set to the register, and when the specific operation flag 350 is not established (turned off), a data value “0” is set to the register.

The operation counter 352 is a counter for counting a time from when a touch is detected by the touch panel 36. The counting result by the operation counter 352 is used for determining whether or not an operation time is larger than a threshold value T. The release counter 354 is a counter for counting a time from a release after the insensitive section is set. The counting result by the release counter 354 is used for determining whether or not the insensitive section is to be canceled.

Although illustration is omitted, in the data memory area 304, an image file, etc. are stored, and other counters and flags that are required for operating the mobile terminal 10 are also provided. Furthermore, each counter and each flag are set to “0” at initial state.

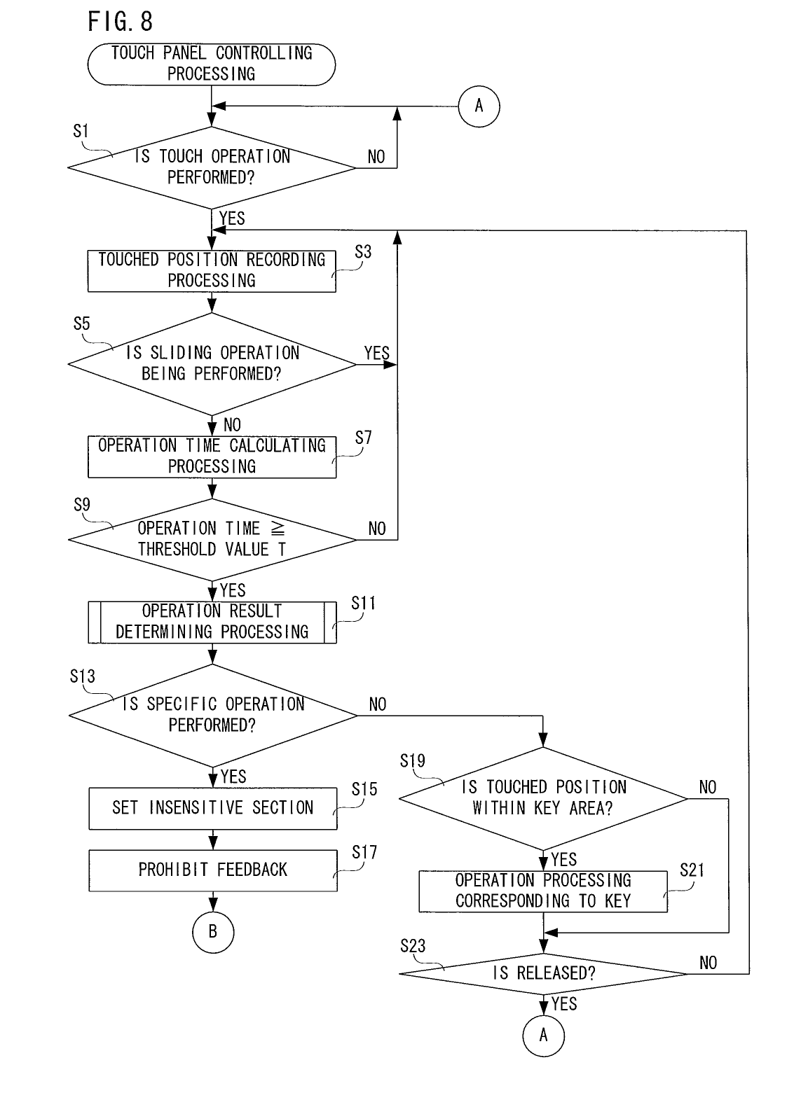

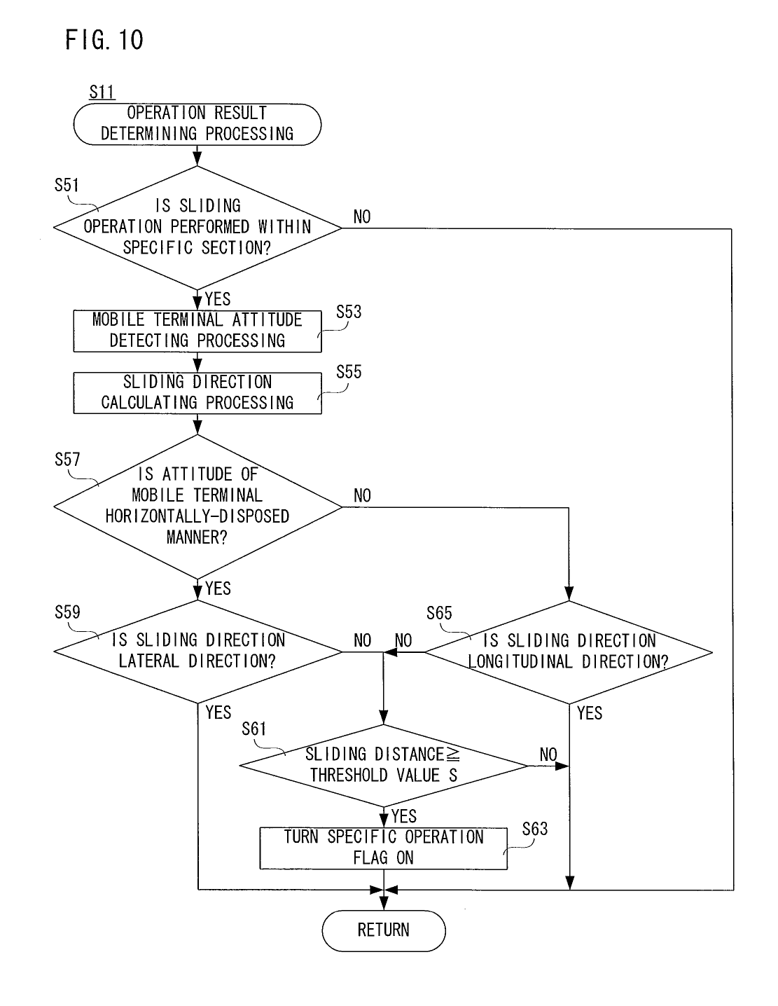

The CPU 20 executes in parallel a plurality of tasks including touch panel controlling processing shown in FIG. 8 and FIG. 9 and operation result determining processing, etc. shown in FIG. 10 under the control of the RTOS (real-time operating system), such as “Linux®” and “REX”.

For example, when the user touches the touch panel 36 of the mobile terminal 10, the CPU 20 performs the touch panel controlling processing as shown in FIG. 8, and determines whether or not a touch operation is performed in a step S1. That is, in the step S1, it is determined whether or not the touch flag 344 is turned on. If “NO” in the step S1, that is, if the touch flag 344 is turned off, the determination in the step S1 is repeatedly executed. On the other hand, if “YES” in the step S1, that is, if the touch flag 344 is turned on, touched position recording processing is executed in a step S3. That is, in the step S3, the coordinate data of the current touched position stored in the touched position buffer 330 is recorded as touched position accumulative data 338.

Succeedingly, in a step S5, it is determined whether or not a sliding operation is being performed. That is, in the step S5, it is determined whether or not the coordinate data of the current touched position stored in the touched position buffer 330 is changed. If “YES” in the step S5, that is, if a sliding operation is being performed, the process returns to the step S3.

Here, the processing in the steps S3 and S5 are repeated within about 10 ms, but recording the coordinate data of the current touched position as the touched position accumulative data 338 in the step S3 shall be performed every ten times. This is because when the coordinate data is recorded about every 10 ms, the data amount of the touched position accumulative data 338 is massive to constrain the storage capacity of the RAM 32. That is, in a case that the processing in the steps S3 and S5 are repeated, the coordinate data of the touched position is recorded about every 100 ms as the touched position accumulative data 338.

On the other hand, if “NO” in the step S5, that is, if a sliding operation is not being performed, operation time calculating processing is executed in a step S7. That is, in the step S7, a time from when a touch is detected to when a sliding operation is ended shall be evaluated as an operation time. More specifically, the accumulated coordinate data of the touched position recorded in the touched position accumulative data 338 are utilized. As described before, the coordinate data of the touched position is recorded as touched position accumulative data 338 about every 100 ms, and therefore, from the number of accumulated touched position accumulative data 338 and the time during which the coordinate data is accumulated, the operation time from the start of the touch can be calculated. Here, by the operation counter 352, the number of accumulated data included in the touched position accumulative data 338 is counted. Then, as shown in Equation 1, by evaluating the product of the count value of the operation counter 352 and the time during which the coordinate data is accumulated, it is possible to calculate the operation time.

operation time=(operation counter 352).times.(time during which the coordinate data is accumulated) [Equation 1]

For example, the time during which the coordinate data is accumulated is about 100 ms, and therefore, if the value of the operation counter 352, that is, the number of accumulated data included in the touched position accumulative data 338 is “3”, that approximate 300 ms have elapsed from the detection of a touch can be evaluated from Equation 1.

Here, at the same time that the touch flag 344 is turned on, time loop processing is executed to thereby evaluate the operation time. More specifically, the number of times that the time loop processing repeat is counted by the operation counter 352, and from the product of the processing time of the time loop processing and the count value of the operation counter 352, the operation time is evaluated.

Succeedingly, in a step S9, it is determined whether or not the operation time is equal to or more than a threshold value T. That is, in the step S9, it is determined whether or not the operation time from when a touch is detected to when a sliding operation is ended is equal to or more than the threshold value T. Here, the threshold value T shall be 500 ms. Thus, in the step S9, it is determined whether or not the operation time from when a touch is detected to when a sliding operation is ended is equal to or more than 500 ms. Here, the threshold value T may be equal to or more than 500 ms, and may be less than 500 ms.

Here, if “NO” in the step S9, that is, if the operation time is less than 500 ms, the process returns to the step S3. On the other hand, if “YES” in the step S9, that is, if the operation time is equal to or more than 500 ms, the operation result determining processing is executed in a step S11. That is, in the step S11, it is determined whether or not the sliding operation performed by the user is a specific operation, and if it is the specific operation, the specific operation flag 350 is turned on. Furthermore, the operation result determining processing is explained in detail in the flowchart of the operation result determining processing shown in FIG. 10, and is thus omitted here.

Succeedingly, it is determined whether or not a specific operation is performed in a step S13. That is, it is determined whether or not the specific operation flag 350 is turned on. If “NO” in the step S13, that is, if the specific operation flag 350 is turned off, the process proceeds to a step S19. On the other hand, if “YES” in the step S13, that is, if the specific operation flag 350 is turned on, the insensitive section is set in a step S15. That is, the coordinate data of the touch sensitive area is recorded as the insensitive section coordinate data 340. Then, in a step S17, feedback is prohibited, and the process proceeds to a step S31. That is, in the step S17, the motion of the motor 40 is suspended to prohibit an operation of the feedback.

Here, in the step S19, that is, if “NO” in the step S13, it is determined whether or not the touched position is within the key area. That is, it is determined whether or not the coordinate data of the current touched position is included in the key area data 342a, such as the menu key 50, the channel key 52, the volume key 54, etc. If “YES” in the step S21, that is, if the coordinate data of the current touched position is within the key area of the channel key 52, operation processing corresponding to the key is executed in a step S21, and the process proceeds to a step S23. That is, in response to an operation of the channel key 52, the channel number of the digital broadcast is changed. On the other hand, if “NO” in the step S19, that is, if the coordinate data of the current touched position is not included in any operation key area, the process proceeds to the step S23.

Succeedingly, in the step S23, it is determined whether or not a release is performed. That is, it is determined whether or not the touch flag 344 is turned off. Here, if “NO” in the step S23, that is, if the touch flag 344 is turned on, the accumulated coordinate data included in the touched position accumulative data 388 and the operation counter 352 are reset, and the process returns to the step S3. On the other hand, if “YES” in the step S23, that is, if the touch flag 344 is turned off, touched position buffer 330, the accumulated coordinate data included in the touched position accumulative data 388, and the operation counter 352 are reset, and the process returns to the step S1.

With reference to FIG. 9, in the step S31, it is determined whether or not a release is performed. That is, it is determined whether or not the touch flag 344 is turned off. If “NO” in the step S31, that is, if the touch flag 344 is turned on, the processing in the step S31 is repeated. That is, as long as the finger is not released from the touch panel 36 after the insensitive section is set, the insensitive section remains to be set. On the other hand, if “YES” in the step S31, that is, if the touch flag 344 is turned off, releasing time calculating processing is executed in a step S33. That is, in the step S33, the time from when the release is performed from the touch panel 36 (releasing time) is calculated. More specifically, at the same time that the touch flag 344 is turned off, the count processing is executed to repetitively count by the release counter 354. Then, from the product of the time during which the count processing is repeated and the count value of the release counter 354, the releasing time is calculated. Furthermore, the releasing time calculating processing is ended if the touch flag 344 is turned on.

Successively, in a step S35, it is determined whether or not the releasing time is equal to or more than a threshold value R. Here, the threshold value R shall be 1000 ms. Thus, in the step S35, it is determined whether or not the time from when the user releases the finger from the touch panel 36 is equal to or more than 1000 ms. Furthermore, the processing in the step S35 is executed at the same time that the processing in the step S33 is executed, that is, whether or not the releasing time is equal to or more than the threshold value R is determined as soon as the execution of the step S33. Here, the threshold value R may be equal to or more than 1000 ms, or less than 1000 ms.

If “NO” in the step S35, that is, if the releasing time is less than the threshold value R, the process returns to the step S31. On the other hand, if “YES” in the step S35, that is, if the releasing time is equal to or more than the threshold value R, the insensitive section is canceled in a step S37. That is, the insensitive section coordinate data 340 is reset.

Thus, the user can easily cancel the insensitive section by merely releasing the finger from the touch panel. In addition, if the releasing time falls within the predetermined time, even if the user releases the finger from the touch panel 36, the insensitive section is not canceled, capable of improving user's convenience.

Successively, in a step S39, the prohibition of the feedback is canceled. That is, the motor 40 is activated. Then, the touched position buffer 330, the accumulated coordinate data in the touched position accumulative data 388, the operation counter 352 and the release counter 354 are reset, and the process returns to the step S1.

That is, in accordance with the cancelation of the insensitive section, the feedback operation is restarted, and therefore, the user can clearly perceive setting or cancelation of the insensitive section.

FIG. 10 is a flowchart showing the operation result determining processing in the step S11 (see FIG. 8). The CPU 20 determines whether or not a sliding operation is performed within the specific section in a step S51. That is, it is determined whether or not the coordinates of the starting point of the touch and the current touched position that are stored in the touched position buffer 330 and the accumulated coordinate data included in the touched position accumulative data are included within the area represented by the specific section coordinate data 334. Here, it may be determined whether or not all the accumulated data included in the touched position accumulative data 338 are included in the area represented by the specific section coordinate data 334.

If “NO” in the step S51, that is, if a sliding operation is not performed within the specific section, the operation result determining processing is ended, and the process returns to the touch panel controlling processing shown in FIG. 8. On the other hand, if “YES” in the step S51, that is, if a sliding operation is performed within the specific section, mobile terminal attitude detecting processing is executed in a step S53. That is, whether the mobile terminal 10 is in the horizontally-disposed manner shown in FIG. 3(A) or the vertically-disposed manner shown in FIG. 3(B) by the accelerometer 38. If the mobile terminal 10 is in the horizontally-disposed manner, the mobile terminal attitude flag 346 is turned on, and if the mobile terminal 10 is in the vertically-disposed manner, the mobile terminal attitude flag 346 is turned off. Succeedingly, in a step S55, a sliding direction is calculated. That is, a sliding direction as to the sliding operation performed within the specific section is calculated. More specifically, the original point of a touched coordinate system on the touch panel 36 is the upper-left hand corner in the mobile terminal 10 in FIG. 3(B), and an abscissa axis is an X-axis, and an ordinate axis is a Y-axis. Thus, the coordinates of the starting point of the touch shall be (x1, y1), and the coordinates of the current touched position shall be (x2, y2).

Then, in a case that the mobile terminal 10 in the vertically-disposed manner, if Equation 2 is established, that is, if the amount of change in the Y-axis direction is larger than the amount of change in the X-axis direction, the sliding direction shall be the longitudinal direction. Furthermore, If Equation 3 is established, that is, if the amount of change in the X-axis direction is larger than the amount of change in the Y-axis direction, the sliding direction is the lateral direction.

On the other hand, in a case that the mobile terminal 10 is the horizontally-disposed manner, if Equation 2 is established, the sliding direction is the lateral direction, and if Equation 3 is established, the sliding direction shall be the longitudinal direction.

|x1−x2|<|y1−y2| [Equation 2]

|x1−x2|.gtoreq.|y1−y2| [Equation 3]

For example, in a case of the horizontally-disposed manner shown in FIG. 5(A), when a sliding operation is performed from bottom to up by the thumb, the sliding direction is the longitudinal direction. On the other hand, in a case of the vertically-disposed manner in FIG. 5(B), when a sliding operation is performed from right to left, the sliding direction is the lateral direction.

Thus, if the sliding direction is the lateral direction, the sliding direction flag 348 is turned on, and if the sliding direction is the longitudinal direction, the sliding direction flag 348 is turned off.

Succeedingly, in a step S57, it is determined whether or not the attitude of the mobile terminal is the horizontally-disposed manner. That is, it is determined whether or not the mobile terminal attitude flag 346 is turned on. If “NO” in the step S57, that is, if the attitude of the mobile terminal is the vertically-disposed manner, the process proceeds to a step S65. On the other hand, if “YES” in the step S57, that is, if the attitude of the mobile terminal is in the horizontally-disposed manner, it is determined whether or not the sliding direction is the lateral direction in a step S59. That is, it is determined whether or not the sliding direction flag 348 is turned on. If “YES” in the step S59, that is, if the sliding direction is in the lateral direction, the operation result determining processing is ended.

On the other hand, if “NO” in the step S59, that is, if the sliding direction is the longitudinal direction, it is determined whether or not a sliding distance is equal to or more than the threshold value S in a step S61. Here, the threshold value S shall be the distance of one third of the width direction of the LCD monitor 26 (see FIG. 2). That is, it is determined whether or not the sliding distance according to a sliding operation by the user is equal to or more than the distance one third of the width direction of the LCD monitor 26. Furthermore, the sliding distance can be evaluated on the basis of the coordinates of the starting point of the touch and the current touched position by using Pythagorean theorem. Here, the threshold value S may be larger or smaller than the distance one third of the width direction of the LCD monitor 26.

If “NO” in the step S61, that is, if the sliding distance is less than the threshold value S, the operation result determining processing is ended. On the other hand, if “YES” in the step S61, that is, if the sliding distance is equal to or more than the threshold value S, the specific operation flag 350 is turned on in a step S63, and the operation result determining processing is ended. That is, the sliding direction is in the longitudinal direction within the operation area R2 if the attitude of the mobile terminal is the horizontally-disposed mariner as to the sliding operation by the user, that is, a specific relationship is established, and therefore, the sliding operation is determined as a specific operation.

Here, in a step S65, it is determined whether or not the sliding direction is the longitudinal direction. That is, it is determined whether or not the sliding direction flag 348 is turned off. If “YES” in the step S65, that is, if the sliding direction flag 348 is turned off, the operation result determining processing is ended. On the other hand, if “NO” in the step S65, that is, if the sliding direction flag 348 is turned on, the process proceeds to a step S61. That is, the attitude of the mobile terminal is in the vertically-disposed manner, the sliding direction is the lateral direction within the operation area R2, and therefore, it is determined whether or not the sliding distance is equal to or more than threshold value S in the step S61. In addition, if the sliding distance is equal to or more than the threshold value S, the specific operation flag 350 is turned on in a step S63.

As can be understood from the above description, on the LCD monitor 26 of the mobile terminal 10, the operation area R2 including the menu key 50, the channel key 52 and the volume key 54 is displayed. Then, when a sliding operation being the specific operation is performed within the operation area R2, the operation area R2 can be set as an insensitive section. For example, if the attitude of the mobile terminal is in the horizontally-disposed manner with respect to the touch panel 36, the user performs a sliding operation such that the sliding direction is the longitudinal direction within the operation area R2 to thereby set the insensitive section.

Thus, the user can set the insensitive section on the touch panel 36 by merely performing a sliding operation in correspondence with the attitude of the mobile terminal

Furthermore, in accordance with the attitude of the mobile terminal as to how the mobile terminal 10 is held, a sliding operation that is easily operable for the user can be decided as a specific operation, and therefore, the user can perform an easily operable sliding operation irrespective of the attitude of the mobile terminal.

Then, the range where a sliding operation is determined as a specific operation is made within only the operation area R, and whereby, the user can perform an operation by making a discrimination between a sliding operation being the specific operation and a normal operation being the key operation.

Here, the specific operation is detected within the specific section (operation area R2), but the specific operation may be determined by regarding the touch panel responsive area as a specific section. Furthermore, the specific operation may be a sliding operation of drawing a circle or a triangle. In addition, the threshold values T, R, S used in the first embodiment shall take the same values in other embodiments.

Furthermore, when the touch panel 36 conforms to detection of a plurality of touched points, the respective touched points are processed in parallel. Then, if the insensitive section is set to a part of the touch sensitive area within the touch panel 36, with a first touch operation, the insensitive section is set, and with a second touch operation successively performed, the key out of the insensitive section is operatable. That is, the user can operate the mobile terminal 10 by the touch panel 36 even if the insensitive section is set.

### Second Embodiment

In the second embodiment, processing of capable of arbitrarily setting the wideness of the insensitive section is explained. It should be noted that the second embodiment is the same as the first embodiment in the configuration of the mobile terminal 10 explained in FIG. 1, the illustrative view showing the appearance of the mobile terminal 10 in FIG. 2, the illustrative view showing the appearance of the mobile terminal 10 that executes the TV displaying function in FIG. 3 and FIG. 4, the memory map shown in FIG. 6 and the flowchart shown in FIG. 8, and therefore, a redundant explanation is omitted.

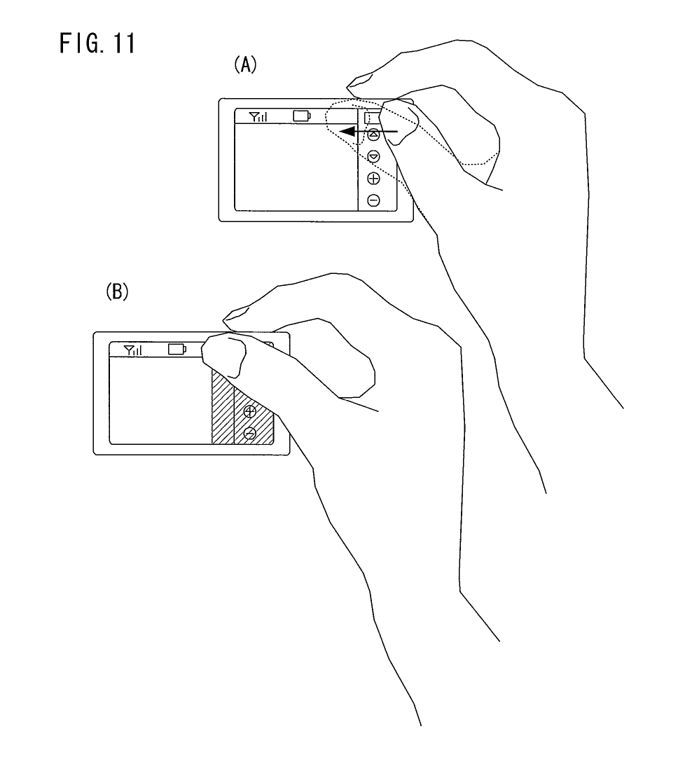

In the second embodiment, by a sliding operation not in the specific section, but from the specific position A, the insensitive section can be set. As shown in FIG. 11, in a case that the attitude of the mobile terminal is in the horizontally-disposed manner, when a sliding operation is performed from the specific position A (see FIGS. 3(A), (B)) in the lateral direction as a sliding direction, an area in the Y-axis direction from the specific position A to the coordinates of the current touched position is set as an insensitive section as shown in FIG. 11(B). Here, the specific position A may be the other vertexes of the LCD monitor 26, or may be set at an arbitrary position by the user. In addition, without being restricted to the specific position A, a specific side is applicable. For example, this may be one side of the LCD monitor 26 in the lengthwise direction or the other side in the lengthwise direction.

Furthermore, in the second embodiment, even if a release is performed, the insensitive section is not canceled. In order to cancel the insensitive section, in a case that the attitude of the mobile terminal is in the horizontally-disposed manner, the user performs a sliding operation in the lateral direction as a sliding direction and releases the finger at the specific position A to thereby cancel the insensitive section. Thus, after the insensitive section is set, even if the holding manner is changed many times, the set insensitive section is not cancelled, capable of improving user's convenience.

Alternatively, in a case that the attitude of the mobile terminal is in the vertically-disposed manner, when a sliding operation in the longitudinal direction as a sliding direction is performed from the specific position A, the insensitive section can be set in correspondence with the sliding distance. In a case that the insensitive section is to be canceled, a sliding operation in the longitudinal direction as a sliding direction is performed such that the released point may be coincident with the specific position A.

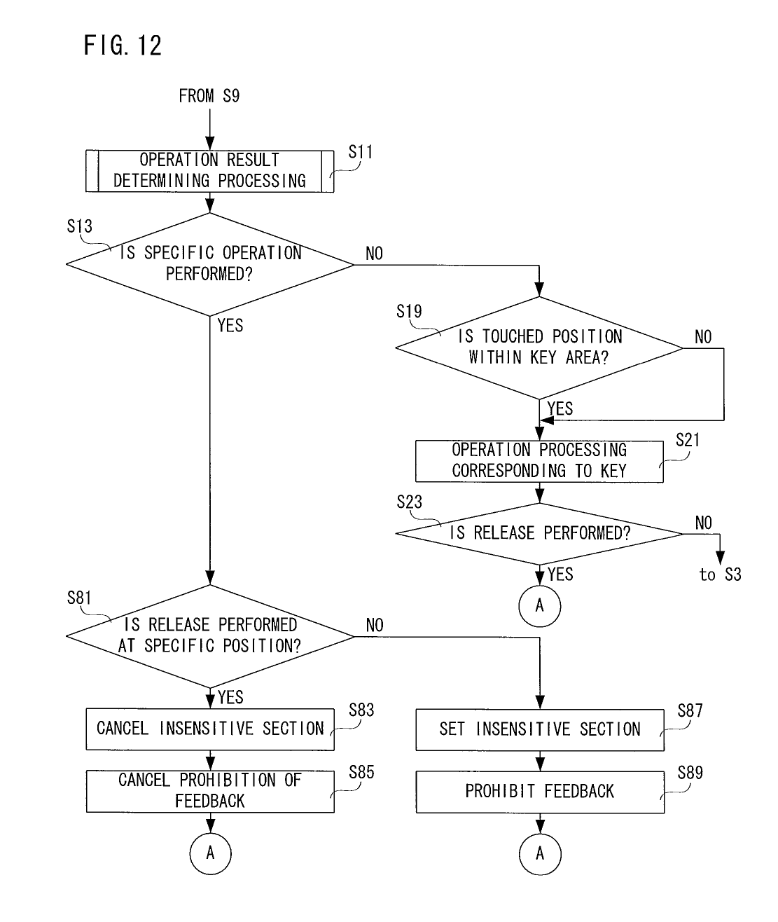

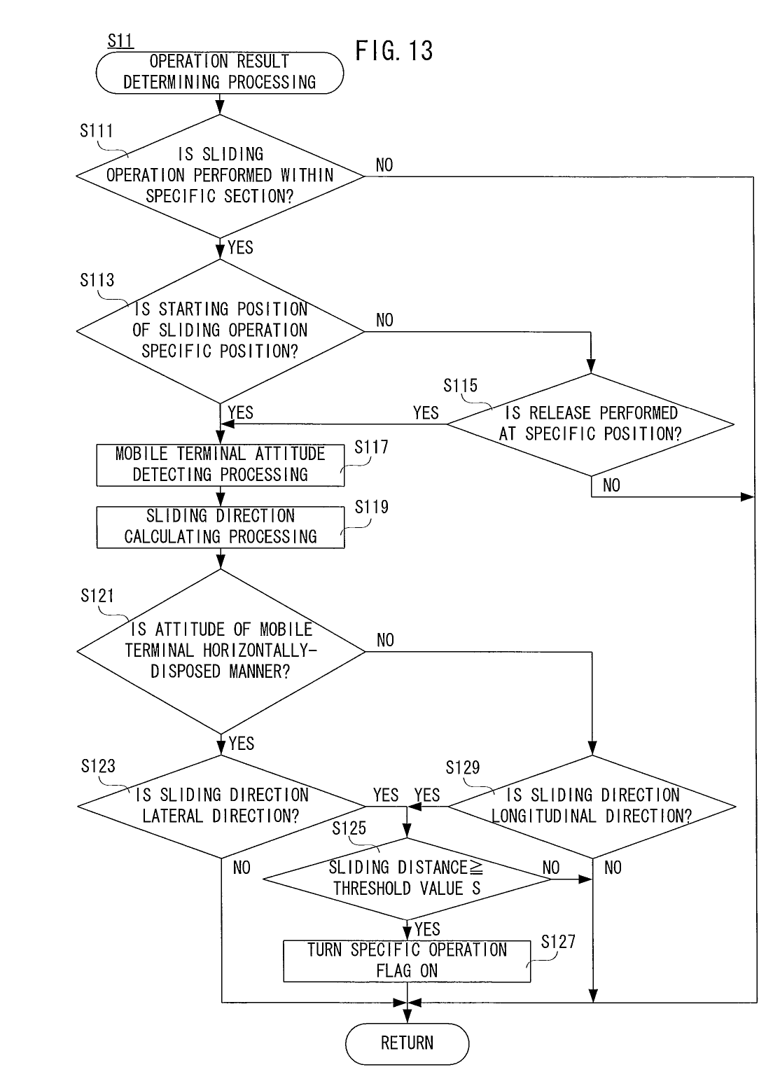

The CPU 20 executes in parallel a plurality of tasks including touch panel controlling processing shown in FIG. 12, operation result determining processing shown in FIG. 13, etc. under the control of the RTOS (real-time operating system), such as “Linux (registered trademark)”, “REX”, etc.

When the user touches the touch panel 36 of the mobile terminal 10, the CPU 20 starts the touch panel controlling processing. Here, in the processing in the steps S1-S9 (see FIG. 8), the processing the same as those in the first embodiment are executed, and therefore, the detailed explanations thereof is omitted. After completion of the step S9, with reference to FIG. 12, in the step S11, operation result determining processing is executed. The processing in the step S11 is different from that in the first embodiment. Furthermore, the step S11 in the second embodiment is explained by using a flowchart shown in FIG. 13, and thus, a detailed explanation thereof is omitted here. Succeedingly, in the step S13, it is determined whether or not the specific operation is performed. If “NO” in the step S13, that is, if the specific operation is not performed, processing in the steps S19-S23 are performed similar to the first embodiment.

On the other hand, if “YES” in the step S13, that is, if the specific operation is performed, it is determined whether or not a release is performed at the specific position A in a step S81. That is, it is determined whether or not the coordinate data of the end point of the touch stored in the touched position buffer 330 and the coordinate data of the specific position coordinate data 336 are coincident with each other. If “NO” in the step S81, that is, if a release is not performed at the specific position A, the insensitive section is set in a step S87, and the feedback is prohibited in a step S89. Then, after completion of the step S89, the process returns to the step S1 (see FIG. 8). On the other hand, if “YES” in the step S81, that is, if a release is performed at the specific position A, the insensitive section is canceled in a step S83, and the prohibition of the feedback is canceled in a step S85. Then, after completion of the step S85, the process returns to the step S1.

FIG. 13 is a flowchart showing the operation result determining processing in the step S11 (see FIG. 12) in the second embodiment. The CPU 20 determines whether or not a sliding operation is performed within the specific section in a step S111. If “NO” in the step S111, that is, if a sliding operation is not performed within the specific section, the operation result determining processing is ended. On the other hand, if “YES” in the step S111, that is, if a sliding operation is performed within the specific section, it is determined whether or not the starting position of the sliding operation is the specific position A in a step S113. That is, it is determined whether or not the coordinate data of the starting point of the touch stored in the touched position buffer 330 and the coordinate data of the specific position coordinate data 336 are coincident with each other.

If “YES” in the step S113, that is, if the starting position of the sliding operation and the specific position A are coincident with each other, the process proceeds to a step S117. On the other hand, if “NO” in the step S113, that is, if the starting position of the sliding operation and the specific position A are not coincident with each other, it is determined whether or not a release is performed at the specific position A in a step S115.

If “NO” in the step S115, that is, a release is not performed at the specific position A, the operation result determining processing is ended, and the process returns to the touch panel controlling processing shown in FIG. 12. On the other hand, if “YES” in the step S115, that is, if a release is performed at the specific position A, the mobile terminal attitude detecting processing is performed in the step S117, and the sliding direction calculating processing is executed in a step S119.

Succeedingly, in a step S121, it is determined whether or not the attitude of the mobile terminal is the horizontally-disposed manner. If “NO” in the step S121, that is, if the attitude of the mobile terminal is the vertically-disposed manner, the process proceeds to a step S129. On the other hand, if “YES” in the step S121, that is, if the attitude of the mobile terminal is the horizontally-disposed manner, it is determined whether or not the sliding direction is the lateral direction in a step S123. If “NO” in the step S123, that is, if the attitude of the mobile terminal is the horizontally-disposed manner, and the sliding direction is the longitudinal direction, it is determined that the specific operation is not performed, and therefore, the operation result determining processing is ended.

If “YES” in the step S123, that is, if the sliding direction is the lateral direction, it is determined whether or not the sliding distance is equal to or more than the threshold value Sin a step S125. If “NO” in the step S125, that is, if the sliding distance is less than the threshold value S, the operation result determining processing is ended. On the other hand, if “YES” in the step S125, that is, if the sliding distance is equal to or more than the threshold value S, the specific operation flag 350 is turned on in a step S127, and the operation result determining processing is ended. That is, in a case that the attitude of the mobile terminal is the horizontally-disposed manner, if the sliding distance is equal to or more than the threshold value S, and the sliding direction is the lateral direction, it is determined that the specific operation is performed.

In a step S129 here, it is determined whether or not the sliding direction is the longitudinal direction. That is, in a case that the attitude of the mobile terminal is the vertically-disposed manner, it is determined whether or not the sliding direction is the longitudinal direction. If “NO” in the step S129, that is, if the sliding direction is the lateral direction, the operation result determining processing is ended. On the other hand, if “YES” in the step S129, the process proceeds to the step S125. That is, in a case that the attitude of the mobile terminal is the vertically-disposed manner, if the sliding distance is equal to or more than the threshold value S, and the sliding direction is the longitudinal direction, it is determined that the specific operation is performed.

Then, in the step S87 (see FIG. 12), the area represented by the specific position A and the current touched position (or end point of the touch) can be set as an insensitive section.

Thus, if a specific operation (sliding operation) for which the specific position A is the starting point of the touch is performed, the insensitive section is set, and if a specific operation (sliding operation) for which the specific position A is the end point of the touch is performed, the setting of the insensitive section is canceled.

As can be understood from the explanation described above, in the processing of the step S11 in the second embodiment, a sliding operation for which the starting point of the touch or the end point of the touch is the specific position A is evaluated as a specific operation. Thus, in the insensitive section setting processing in the step S87, the insensitive section can be set in correspondence with the sliding distance. Furthermore, when a sliding operation is performed such that the specific position A becomes the end point, an insensitive section is canceled.

That is, a sliding operation is merely performed such that the end point of the touch becomes the specific position A in the sliding direction in correspondence with the holding attitude as to how the mobile terminal 10 is held to thereby cancel the insensitive section.

Thus, when the user holds the mobile terminal 10 such that the attitude of the mobile terminal 10 and the sliding direction take a relationship decided in advance, and perform a sliding operation such that the end point becomes the specific position, it is possible to cancel the insensitive section. That is, the user can operate the touch panel by making a discrimination between the operation of cancelling the insensitive section and the operation of holding the mobile terminal 10.

Furthermore, the user can arbitrarily set the size of the insensitive section in correspondence with the sliding distance of the sliding operation.

Moreover, in the second embodiment, by only the sliding distance within the specific section, the specific operation is determined without determining the attitude of the mobile terminal, and the insensitive section may be set.

### Third Embodiment

In third embodiment, as to a mobile terminal 10 having a plurality of touch switches in place of the touch panel, a setting of an insensitive section for each of the plurality of touch switches is explained.

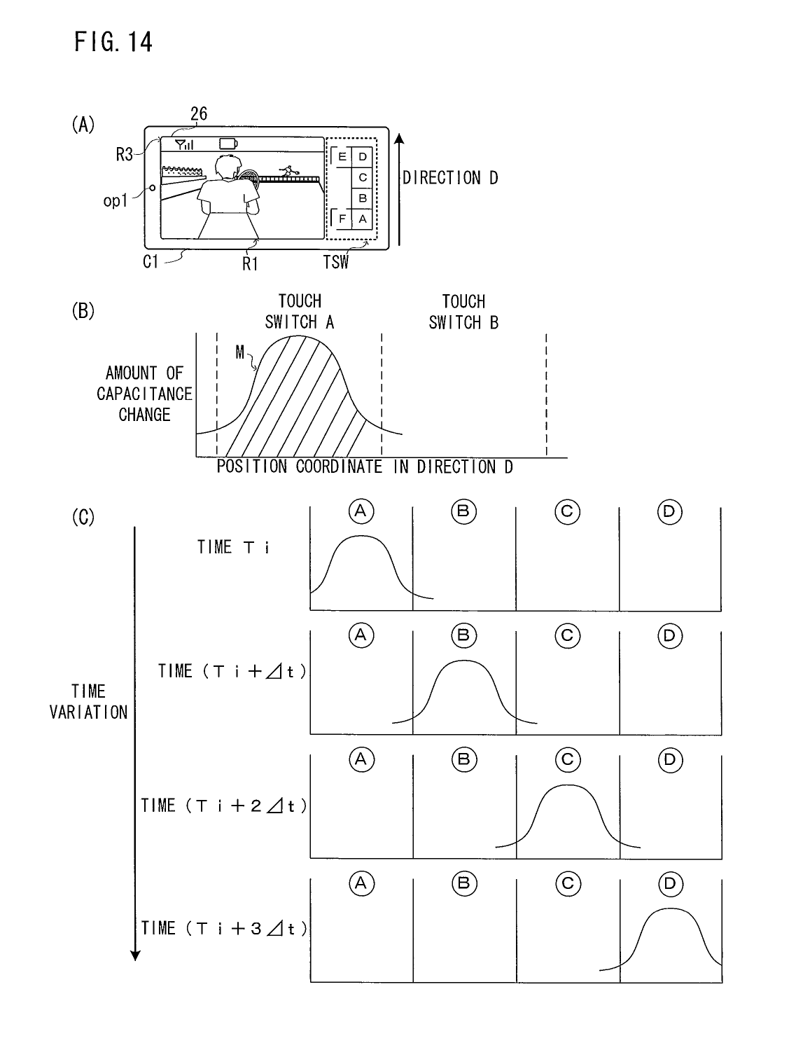

In the third embodiment, the configuration of the mobile terminal 10 is approximately the same as that of the first embodiment, but it is provided with a touch switch TSW in place of the touch panel 36. Furthermore, the appearance of the mobile terminal 10 is approximately the same as the first embodiment. However, with reference to FIG. 14(A), the touch switch TSW is made up of a plurality of touch switches A-F, and provided on the top surface at one end in the longitudinal direction of the case C1 so as to be adjacent with the LCD monitor 26. Each of the touch switches A-F included in the touch switch TSW is independent of one another, and each touch switch can detect a touch. Furthermore, each touch switch is arranged to be adjacent with each other. That is, the touch switch A is adjacent with the touch switches B, F, the touch switch B is adjacent with the touch switches A, C, the touch switch C is adjacent with the touch switches B, D, and the touch switch D is adjacent with the touch switches C, E.

The touch switches A, B correspond to the volume adjustment key in the first embodiment, and the touch switches C, D correspond to the channel key in the first embodiment. Furthermore, the touch switches E, F which are set so as not to be visually recognized are utilized for setting the insensitive section. Then, when the touch switch TSW detects a touch, a feedback operation is performed by the motor 40 similar to the first embodiment.

The touch switches A-F included in the touch switch TSW detect a touch by the electrical capacitance type similar to the touch panel 36. Here, in a case that a touch is detected by the touch switch A, the amount of capacitance change in the touch switch A is explained.

FIG. 14(B) is a graph showing the amount of capacitance changes in the touch switch A and the touch switch B during detection of the touch. In the graph regarding the lower-left hand corner as an original point, the abscissa axis indicates a position coordinate in the direction D (see FIG. 14(A)), and the ordinate axis indicates the amount of capacitance change. Thus, from the graph, the amount of capacitance change with respect to the position coordinate in the direction D can be read. It is found that the finger also touches the touch switch B from the graph, but the amount of change in the touch switch A (area of the diagonally shaded part M) is the largest, and therefore, it is recognized that the touch switch A is touched. Furthermore, the amount of capacitance change varies like a mount, and the largest position coordinate in the direction D is coincident with the central point of the touch switch A, and thus, it is found that the center of the finger touched by the user (the center of gravity of the area of the finger) is positioned in the center of the touch switch A.

Here, an operation of sliding to the adjacent touch switch without releasing the touched touch switch is called “touch sliding operation”. Furthermore, the amount of capacitance change in each of the touch switches A-D is varied as shown in FIG. 14(C). The explanation is made in detail by using FIG. 14(C) below.

FIG. 14(C) is an illustrative view showing a time variation of the capacitance from the touch switch A to the touch switch D in a case that a touch sliding operation is performed from the touch switch A to the touch switch D. Referring to FIG. 14(C), “A”-“D” respectively correspond to the touch switches A-D. Each graph corresponding to “A”-“D” is the same as that shown in FIG. 14(B), and represents the amount of capacitance change in the touch switch A-D with respect to the position coordinate in the direction D. Four graphs at the uppermost line represent the amount of capacitance change of the touch switches A-D at a time Ti, and each of the four graphs vertically arranged represents the amount of capacitance change of the touch switches A-D after each of the times .DELTA.t, 2.DELTA.t, 3.DELTA.t from the time Ti. Furthermore, the user performs a touch sliding operation from the touch switch A to the touch switch D from the time Ti to the time (Ti+3.DELTA.t).

At the time Ti, the user touches the touch switch A. In this case, the amount of capacitance change at the touched touch switch A becomes the largest, and at the adjacent touch switch B as well, there is a little change in the amount of capacitance change.

Next, at the time (Ti+.DELTA.t) during which the touch sliding operation is performed from the touch switch A to the touch switch B, the amount of capacitance change at the touched touch switch B becomes the largest, and at the adjacent touch switches A, C as well, there are little changes in the amount of capacitance change. Furthermore, in the touch sliding operation, the center of the finger of the user is moved from the center of the touch switch A to the center of the touch switch B, and therefore, the position coordinate in the direction D changes, keeping its the mount-like shape. That is, CPU 20 detects that the maximum value of the amount of capacitance change detected at the touch switches A, B is the same, but the position coordinate in the direction D corresponding to the maximum value is changed.

Succeedingly, at the time (Ti+2.DELTA.t) during which the touch sliding operation is performed from the touch switch B to the touch switch C, the amount of capacitance change at the touched touch switch C becomes the largest, and at the adjacent touch switches B, D as well, there are a little changes in the amount of capacitance change. Then, the CPU 20 can detect that the position coordinate in the direction D corresponding to the maximum value of the amount of capacitance change detected by the touch switch B, C is changed.

Then, at the time (Ti+3.DELTA.t) during which the touch sliding operation is performed from the touch switch C to the touch switch D, the amount of capacitance change at the touched touch switch D becomes the largest, and at the adjacent touch switch C as well, there is a little change in the amount of capacitance change. Then, the CPU 20 can detect that the position coordinate in the direction D corresponding to the maximum value of the amount of capacitance change detected by the touch switch C, D is changed.

That is, the CPU 20 can detect that a touch sliding operation is performed by detecting the change of the position coordinate in the direction D corresponding to the maximum value with the maximum value of the detected amount of capacitance change kept at a predetermined. More specifically, the CPU 20 determines a touch sliding operation is performed when the position coordinate in the direction D corresponding to the maximum value of the amount of capacitance is changed from the coordinates of a certain touch switch to the coordinates of the adjacent touch switch.

Hereupon, in the third embodiment, when a touch sliding operation is detected at arbitrary two touch switches, the insensitive section is set to the touch sensitive area of the touch switch TSW. More specifically, if any touch sliding operation is performed from the touch switch A to the touch switch B or the touch switch F, from the touch switch B to the touch switch A or the touch switch C, from the touch switch C to the touch switch B or the touch switch D, from the touch switch D to the touch switch C or the touch switch E, from the touch switch E to the touch switch D, or from the touch switch F to the touch switch A, the insensitive section is set to the touch sensitive area of the touch switch TSW.

The configuration of the memory map of the RAM 32 in the third embodiment is approximately the same as that of the first embodiment, but in the program memory area 302, in place of the touch panel controlling program 312, a touch switch controlling program is stored. Furthermore, in the data memory area 304, a touched position buffer 330 is provided, touched coordinate map data 332 and touched position accumulative data 338 are stored, and a touch flag 344 and a release counter 354 are provided.

Additionally, in the third embodiment, in the touched position buffer 330, position coordinate data in the current direction D and an amount of capacitance change are stored. The touched coordinate map data 332 is data for converting a touched position detected by the touch switch TSW into a position coordinate in the direction D. Then, the position coordinate data in the direction D and the data of the amount of capacitance change that are stored in the touched position buffer 330 every 100 ms are stored in the data memory area 304 as touched position accumulative data 338.

The touch flag 330 is used for determining the presence or absence of a touch on the touch switch TSW. Furthermore, the configuration of the touch flag 330 is the same as that of the first embodiment, and a detailed explanation thereof is omitted. The release counter 354 is used for counting a time from when a touch is released.

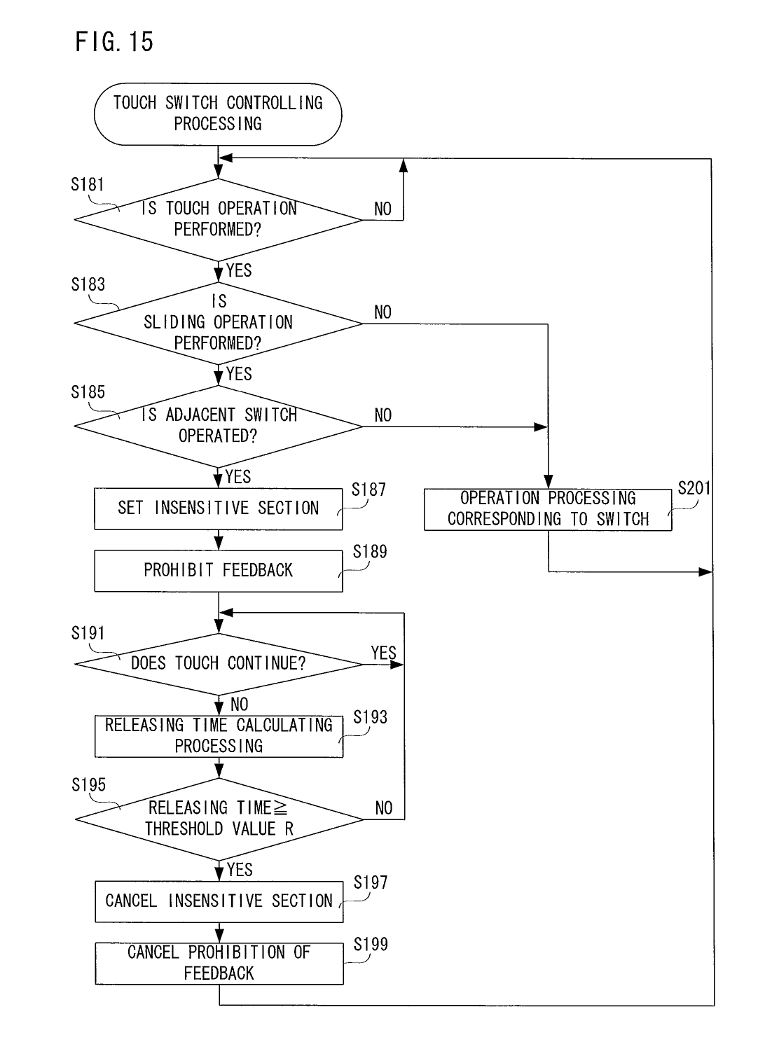

The CPU 20 executes in parallel a plurality of tasks including touch switch controlling processing shown in FIG. 15, etc. in addition to the processing explained in the first embodiment under the control of the RTOS (real-time operating system), such as the “Linux®” and the “REX”, etc.

For example, when the user touches the touch switch TSW of the mobile terminal 10, the CPU 20 starts the touch switch controlling processing as shown in FIG. 15, and determines whether or not a touch is performed in a step S181. That is, the touch flag 344 is turned on. If “NO” in the step S181, that is, if the touch flag 344 is turned off, the processing in the step S181 is repetitively executed. On the other hand, if “YES” in the step S181, that is, if the touch flag 344 is turned on, it is determined whether or not sliding is performed in a step S183. That is, in the step S183, it is determined whether or not the accumulated position coordinate included in the touched position accumulative data 338 is changed.

If “NO” in the step S183, that is, if sliding is not performed, the process proceeds to a step S201. On the other hand, if “YES”, that is, if sliding is performed, it is determined whether or not an adjacent switch is operated in a step S185. That is, it is determined whether or not an adjacent touch switch is operated by a touch sliding operation. More specifically, it is determined whether or not only the coordinate data of the touched position changes in the accumulated data included in the touched position accumulative data 338 with the maximum value of the amount of capacitance change kept at a predetermined value.

If “NO” in the step S185, that is, if a touch sliding operation is not performed, operation processing corresponding to the switch is executed in the step S201, and then, the process returns to the step S181. For example, if the touch switch D corresponding to a channel operation is touched, the channel number of the received digital broadcast is changed.

If “YES” in the step S185, that is, if a touch sliding operation is performed, the insensitive section is set in a step S187. That is, in the step S187, the insensitive section is set to the touch sensitive area of the touch switch TSW. Succeedingly, in a step S189, a feedback is prohibited. That is, the operation of the motor 40 is suspended.

Succeedingly, in a step S191, it is determined whether or not the touch continues. That is, the touch flag 344 is turned on. If “YES” in the step S191, that is, if the touch flag 344 is turned on, the processing in the step S191 is repetitively executed. On the other hand, if “NO”, that is, if the touch flag 344 is turned off, releasing time calculating processing is executed in a step S193, and it is determined whether or not the releasing time is equal to or more than the threshold value R in a step S195. Here, the processing in the steps S193 and S195 is the same as those in the step S33 and S35 (see FIG. 9), and therefore, a detailed explanation thereof is omitted.

If “NO” in the step S195, that is, if the releasing time is less than the threshold value R, the process returns to the step S191. On the other hand, if “YES”, that is, if the releasing time is equal to or more than the threshold value R, the insensitive section is canceled in a step S197. That is, the insensitive section set with respect to the touch sensitive area of the touch switch TSW is cancelled. Succeedingly, in a step S199, a feedback prohibition is canceled, and the process returns to the step S181. That is, in the step S199, the motor 40 is restarted.

As understood from the above description, even if the touch switch TSW is used in place of the touch panel 36, it is possible to detect that the specific operation is performed on the touch switch TSW and set the insensitive section.

Additionally, in the third embodiment, the attitude of the mobile terminal is the horizontally-disposed manner, but it may be the vertically-disposed manner, and if a touch sliding operation is performed on the touch switch TSW, the insensitive section can be set.

Furthermore, as a communication system of the mobile terminal 10, a W-CDMA system, a TDMA system, a PHS system, and a GSM system may be adopted without being restricted to the CDMA system. A handheld terminal such as a PDA (Personal Digital Assistant), etc. is applicable without being restricted to the mobile terminal 10.

In addition, in the present invention, the specific operation is performed on the specific section to thereby set the insensitive section which makes an input to a part of the touch panel 36 invalid, and makes it possible to use the mobile terminal 10 for holding. Then, in a case that the insensitive section is set, the specific operation is performed on the specific section to thereby cancel the insensitive section. Furthermore, in order that an operation for setting the insensitive section exerts an influence on a key operation, a normal key operation may be set to be performed not at a time when a touch is performed but when a touch is performed for a predetermined time, or when the touch is released. This has an advantage of being free from the key operation even if a touch is kept and away from the key area.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mobile terminal, comprising:
a display displaying at least one operation key within a section on a side edge of a display area of said display;
a touch panel, which is provided in association with said display, operable to detect a touch within the display area of said display; and
one or more modules that
determine whether or not a specific operation is performed on the basis of a position of a touch detected by said touch panel, wherein the specific operation comprises a continuous touch, and,
when it is determined that the specific operation is performed,
set the section of the display area having the at least one operation key in an insensitive state, such that said at least one operation key is visible but not operable, and
when the continuous touch is released for longer than the predetermined period of time, set the section of the display area having the at least one operation key in a sensitive state, such that said at least one operation key is visible and operable.

2. A mobile terminal according to claim 1, wherein said specific operation further comprises a slide from a first position to a second position.

3. A mobile terminal according to claim 2, wherein said specific operation requires that the slide be performed in a predetermined sliding direction.

4. A mobile terminal according to claim 2, wherein said specific operation requires that the slide be performed in a sliding direction having a predetermined relationship with an attitude of the mobile terminal.

5. A mobile terminal according to claim 2, wherein said specific operation requires that the first position of the slide is a predetermined position within the section of the display area having the at least one operation key.

6. A mobile terminal according to claim 2, wherein said specific operation requires that the first and second positions of the slide are within a predetermined section of the display area.

7. A mobile terminal according to claim 1, wherein the one or more modules further:
when the section of the display area having the at least one operation key is in the sensitive state, perform a feedback operation when said touch panel detects a touch input; and,
when the section of the display area having the at least one operation key is in the insensitive state, prohibit said feedback operation when said touch panel detects a touch input.

8. A mobile terminal according to claim 1, wherein the section of the display area having the at least one operation key is formed only on the side edge of the display area.

9. A non-transitory storage medium storing a mobile terminal controlling program of a mobile terminal, wherein said mobile terminal comprises a display displaying at least one operation key within a section on a side edge of a display area of said display, a touch panel operable to detect a touch within the display area of said display, and at least one processor, and wherein, when executed by said at least one processor, said mobile terminal controlling program causes said at least one processor to:
determine whether or not a specific operation is performed on the basis of a position of a touch detected by said touch panel, wherein the specific operation comprises a continuous touch; and,
when it is determined that the specific operation is performed,
set the section of the display area having the at least one operation key in an insensitive state, such that said at least one operation key is visible but not operable, maintain the insensitive state of the section of the display area having the at least one operation key until the continuous touch of the specific operation is released for longer than a predetermined period of time, and,
when the continuous touch is released for longer than the predetermined period of time, set the section of the display area having the at least one operation key in a sensitive state, such that said at least one operation key is visible and operable.

10. A mobile terminal, comprising:
a display;
a touched position, which is provided in association with said display, operable to detect a touch within a display area of said display; and
one or more modules that
determine whether a specific operation is performed on the basis of a position detected by said touch panel,
when it is determined that the specific operation is performed, set a section of said display area in an insensitive state, and
when the touch is released for longer than a predetermined period of time after it is detected that a touch is performed within the section of said display area being set in the insensitive state, set the section of said display area in a sensitive state.

11. A mobile terminal according to claim 21, wherein when the touch is released for longer than the predetermined period of time after it is detected that a touch is performed within the section of said display area being set in the insensitive state during when a moving image is displayed in said display area, set the section of said display area in a sensitive state.
